(19) United States
(12) Patent Application Publication
(10) Pub. No.: US 2002/0178879 A1
(43) Pub. Date: Dec. 5, 2002

(54) Used PCB milling cutter reclamation method

(76) Inventor: Yuan-Wen Yu, Chung Li City (TW)

Correspondence Address: DOUGHERTY & TROXELL, 5205 Leesburg Pike, Suite 1404, Falls Church, VA, 22041, US

(21) Appl. No.: 09/865,452

(22) Filed: May 29, 2001

(51) Int. Cl. B23B 1/00; B23B 3/00

(52) U.S. Cl. 82/1.11; 82/46

(57) ABSTRACT

An used PCB milling cutter reclamation method includes the step of processing the cutting tip and a part of the handle of the damaged PCB milling cutter to form a new cutting tip, the step of processing the end of the handle remote from the new cutting tip to form a round rod, and the step of fastening an end cap to the round rod, keeping the end cap in line as well as in flush with the periphery of the handle.

### BACKGROUND OF THE INVENTION

The present invention relates to PCB milling cutters and, more specifically, to a used PCB milling cutter reclamation method.

A regular PCB milling cutter is made of a tungsten carbide rod. If the cutting edge starts to wear, the PCB milling cutter becomes useless and must be replaced with a new one. Because tungsten carbide material is expensive, it is not economic to throw a PCB milling cutter away when its cutting edge starts to wear. In order to save the money, a damaged PCB milling cutter may be treated for further use. As illustrated in FIG. 1, the damaged cutting edge 11′ of a used PCB milling cutter 10′ is well ground and then mounted with the sleeve 20′, and the handle 12′ of the used PCB milling cutter 10′ is processed to have intersected cutting grooves 13′ on it. However, when installed in the chuck 50′ of a PCB processing machine and locked by a shuck shell 40′, as shown in FIG. 2, the PCB milling cutter 10′ may be not maintained with the sleeve 20′ in a line, i.e., the PCB milling cutter 10′ may be biased from the longitudinal central axis of the sleeve 20′. In this case, the PCB milling cutter 10′ may vibrate when rotated at a high speed to cut the workpiece (the substrate), affecting the cutting precision. Further, the PCB milling cutter 10′ may break when vibrated during its rotary motion.

### SUMMARY OF THE INVENTION

The present invention has been accomplished under the circumstances in view. It is one object of the present invention to provide a used PCB milling cutter reclamation method, which enables damaged PCB milling cutters to be processed for a further use. It is another object of the present invention to provide a used PCB milling cutter reclamation method, which enables the reclaimed PCB milling cutter to achieve a high-precision processing work. According to one aspect of the present invention, the used PCB milling cutter reclamation method includes the step of processing the cutting tip and a part of the handle of the damaged PCB milling cutter to form a new cutting tip, the step of processing the end of the handle remote from the new cutting tip to form a round rod, and the step of fastening an end cap to the round rod, keeping the end cap in line as well as in flush with the periphery of the handle. According to another aspect of the present invention, the end cap has a bottom center plughole, and the round rod of the handle is press-fitted into the bottom center plughole of the end cap.

### BRIEF DESCRIPTION OF THE DRAWINGS

FIG. 1 illustrates a damaged PCB milling cutter reclaimed according to the prior art.

FIG. 2 illustrated the reclaimed PCB milling cutter installed in the chuck of a PCB processing machine according to the prior art.

FIG. 3 illustrates a used PCB milling cutter for reclamation according to the present invention.

FIG. 4 is an exploded view of a reclaimed PCB milling cutter according to the present invention.

FIG. 5 is a sectional assembly view of the reclaimed PCB milling cutter of FIG. 4.

FIG. 6 illustrates the reclaimed PCB milling cutter installed in the chuck of the PCB processing machine according to the present invention.

FIG. 7 illustrates the cutting edge of the cutting tip of the reclaimed PCB milling cutter with a fish tail-like shape according to the present invention.

FIG. 8 illustrates the cutting edge of the cutting tip of the reclaimed PCB milling cutter with a flat bottom shape according to the present invention.

FIG. 9 illustrates the cutting edge of the cutting tip of the reclaimed PCB milling cutter with a twist-like shape according to the present invention.

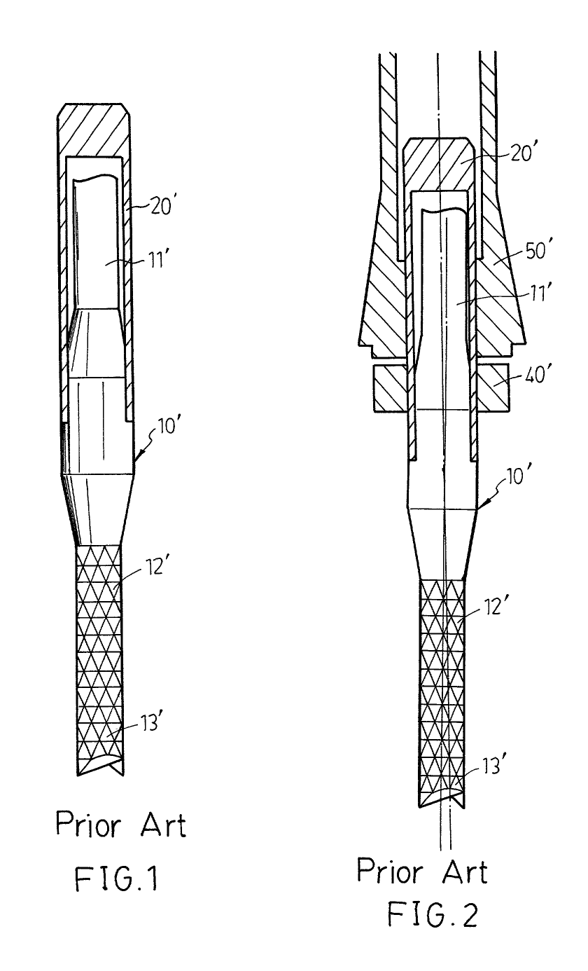

### DETAILED DESCRIPTION OF THE PREFERRED EMBODIMENT

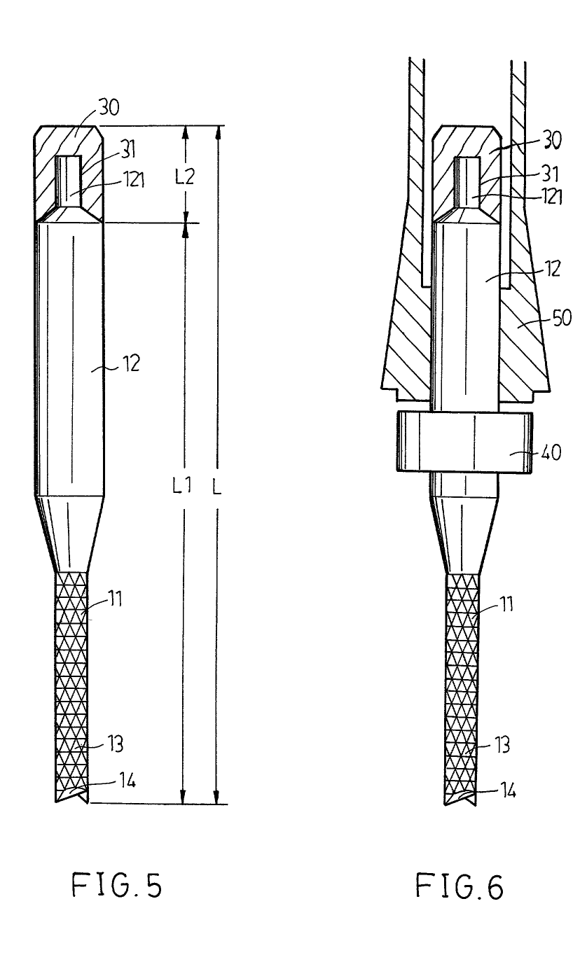

Referring to FIGS. from 3 through 6, the cutting tip 11 and a part of the handle 12 of a damaged PCB milling cutter 10 are well ground and then processed to have intersected cutting grooves 13 on the periphery of the ground cutting tip 11, and then the front end of the cutting tip 11 is processed to form a cutting edge 14. The remote end (the end remote from the cutting tip 11) of the handle 12 is processed into a round rod 121. An end cap 30 is then fastened to the round rod 121 of the handle 12 and maintained in line as well as in flush with the periphery of the handle 12. The end cap 30 has a bottom center plughole 31. The round rod 121 of the handle 12 is press-fitted into the bottom center plughole 31 of the end cap 30. After installation of the end cap 30 in the handle 12, the total length L of the effective length L1 of the reclaimed PCB milling cutter and the length of the end cap 30 is equal to the specified length of the respective specification of PCB milling cutter, i.e., the end of the end cap 30 is made subject to the actual effective length of the reclaimed PCB milling cutter so that a new PCB milling cutter is obtained subject to the desired specification after the installation of the end cap 30 in the handle 12 of the reclaimed PCB milling cutter 10 (see FIG. 5). When in use, the handle 12 of the reclaimed PCB milling cutter is fastened to the chuck 50 of the PCB processing machine and locked in position by a lock ring 40. Because the cutting tip 11 and the handle 12 of the reclaimed PCB milling cutter are maintained perfectly in a line and the handle 12 of the reclaimed PCB milling cutter is fixedly fastened to the chuck 50 of the PCB processing machine, the reclaimed PCB milling cutter does not vibrate when rotated at a high speed to cut the workpiece.

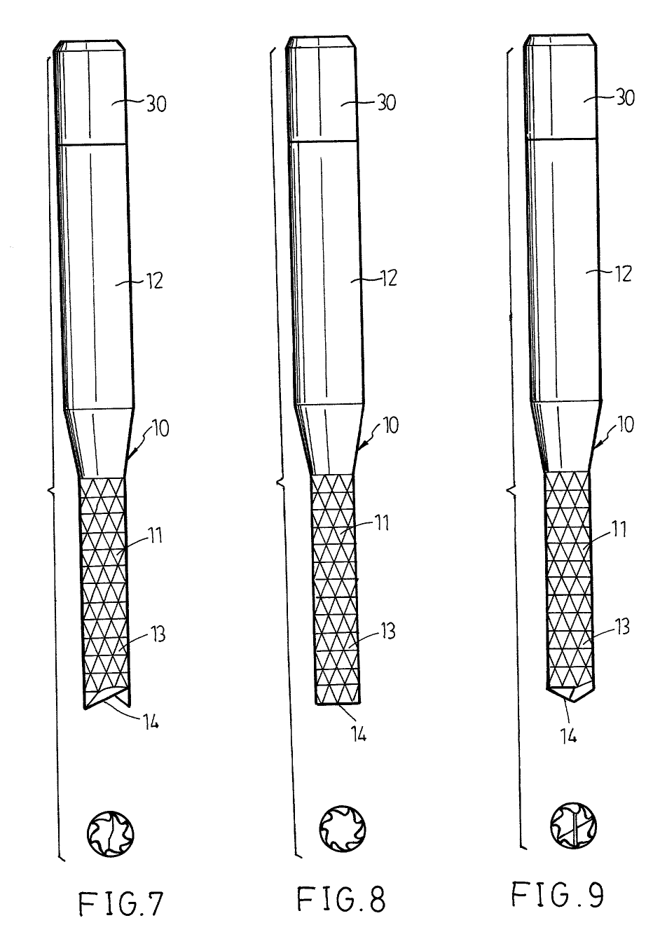

Referring to FIGS. from 7 through 9, the cutting edge 14 of the cutting tip 11 can be made having any of a variety of shapes, for example, the fish tail-like shape as shown in FIG. 7, the flat bottom shape as shown in FIG. 8, or the twist-like shape as shown in FIG. 9.

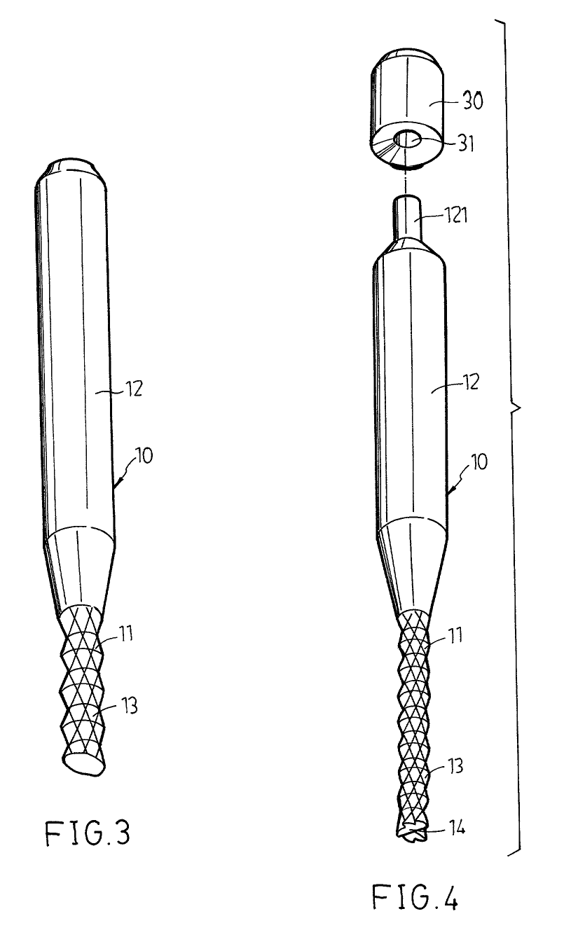

A prototype of milling cutter has been constructed with the features of FIGS. 3˜9. The milling cutter functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An used PCB milling cutter reclamation method adapted to reclaim a damaged PCB milling cutter having a handle and a cutting tip axially extended from one end of said handle, the reclamation method comprising the step of grounding the cutting tip and a part of the handle of the damaged PCB milling cutter to form a new cutting tip, the step of processing said new cutting tip to form intersected cutting grooves on the periphery of said new cutting tip, the step of processing the end of the new cutting tip to form a cutting edge, the step of processing the end of the handle remote from said new cutting tip into a round rod, and the step of fastening an end cap to said round rod, keeping said end cap in line as well as in flush with the periphery of said handle.

2. The used PCB milling cutter reclamation method of claim 1 wherein said end cap has a bottom center plug hole, and said round rod of said handle is press-fitted into the bottom center plug hole of said end cap.
